(19) United States
(12) Patent Application Publication
(10) Pub. No.: US 2025/0369623 A1
(43) Pub. Date: Dec. 4, 2025

(54) HIDDEN MOTORIZED DOOR LATCH ASSEMBLY FOR AN APPLIANCE WITH MANUAL OVERRIDE

(71) Applicant: HTI Technology and Industries, Inc., La Vergne, TN (US)

(72) Inventor: Roger DeYoung, Franklin, TN (US)

(73) Assignee: HTI Technology and Industries, Inc., La Vergne, TN (US)

(21) Appl. No.: 19/221,913

(22) Filed: May 29, 2025

Related U.S. Application Data
(60) Provisional application No. 63/653,455, filed on May 30, 2024.

(51) Int. Cl. F24C 15/02; E05B 47/00; E05B 63/00; E05C 3/14

(52) U.S. Cl. CPC F24C 15/022; E05B 47/0012; E05B 63/0069; E05C 3/145

(57) ABSTRACT

Provided in this disclosure is a latch assembly including a hook for securing a door of an appliance in a closed position. The hook includes a hook shaft extending along a longitudinal axis and a hook end configured at an angle to the longitudinal axis. A hook guide is provided for receiving and retaining the hook. The hook guide is configured to engage the hook shaft for rotation upon linear advancement in the direction of the longitudinal axis. A mechanical linkage is connected to the hook for transmitting the linear advancement to the hook from a motor. An engagement surface is configured to receive the hook end upon rotation. The engagement surface and the hook end are configured for the securing of the door to the appliance in the closed position.

### I. BACKGROUND

### A. Technical Field

This invention pertains to the field of latches for securing a door. The invention particularly pertains to the field of latches for securing an appliance door, such as an oven, especially for self-cleaning ovens which remain secured during a cleaning cycle.

### B. Description of Related Art

Electrically powered latching systems are known in use for appliance doors. In a self-cleaning oven, the doors are secured during a cleaning cycle. During a power failure, it may be necessary for a user to open an appliance door to gain access to the oven area, to inspect, remove items, etc. However, such access is prevented for appliances using an electrically powered latch which maintains the appliance door in a latched state which cannot be readily opened.

### II. SUMMARY

Provided in this disclosure is a latch assembly including a hook for securing a door of an appliance in a closed position. The hook is received within a hook shaft extending along a longitudinal axis and a hook end configured at an angle to the longitudinal axis. A hook guide is provided for receiving and retaining the hook. The hook guide is configured to engage the hook shaft for rotation upon linear advancement in the direction of the longitudinal axis. A mechanical linkage is connected to the hook for transmitting the linear advancement to the hook from a motor. An engagement surface is configured to receive the hook end upon rotation. The engagement surface and the hook end are configured for the securing of the door to the appliance in the closed position.

In another aspect, a hook block assembly is provided for receiving and retaining the hook guide. The hook block assembly includes an internal guide slot configured to engage a guide slot follower protruding from the hook shaft. The guide slot includes a helical portion for guiding the guide slot follower into rotation of the hook along a predetermined rotational angle upon linear advancement of the hook in the direction of the longitudinal axis.

In another aspect, a latch assembly is provided including a hook for securing a door of an appliance in a closed position. The hook includes a hook shaft extending along a longitudinal axis and a hook end configured at an angle to the longitudinal axis. A hook guide is provided for receiving and retaining the hook. A a hook block assembly is provided for receiving and retaining the hook guide. The hook block assembly includes an internal guide slot configured to engage a guide slot follower protruding from the hook shaft. The guide slot includes a helical portion for guiding the guide slot follower into rotation of the hook along a predetermined rotational angle upon linear advancement of the hook in the direction of the longitudinal axis. A mechanical linkage is connected to the hook guide for transmitting the linear advancement to the hook from a motor. An engagement slot of the door of the appliance is configured to receive the hook end upon rotation. The engagement slot and the hook end are configured for the securing of the door of the appliance in the closed position.

In yet another aspect, the guide slot includes a longitudinal portion parallel to the longitudinal axis for linearly guiding the guide slot follower. The longitudinal portion connects with the helical portion. The guide slot follower includes a cylindrical pin extending perpendicularly from the hook shaft, to internally engage the guide slot. The predetermined rotational angle of the helical portion extends 90 degrees, to effect a quarter turn of rotation of the hook end into the engagement slot.

In still another aspect, the hook guide includes a hook block assembly further comprising a guide block matingly connected to a guide block cap. The guide block and guide block cap include an internal bore for receiving and retaining in the hook. The guide slot includes a channel formed within a surface of the internal bore of the guide block and the guide block cap of the hook block assembly. The guide block cap includes an extension guide ramp that extends into the internal bore and includes a sloped contact surface of the helical portion for guiding the guide slot follower into rotation upon extension of the hook. The guide block comprises a retraction guide ramp matingly connected to the extension guide ramp and includes a mating contact surface of the helical portion for guiding the guide slot follower upon retraction of the hook.

In a further aspect, the mechanical linkage includes a motor crank arm in connection with the motor for linearly displacing a link arm configured to rotate a pivot post that displaces a hook arm in connection with the hook for transmitting the linear advancement from the motor. The pivot post includes a hook arm lobe configured to rotate through a predetermined angle of rotation into a switch button of a hook position switch. Engagement of the hook arm lobe and the switch button generates a signal to discontinue the linear advancement of the motor.

In another further aspect, the latch assembly is mounted onto the appliance of an existing design. The engagement slot includes a ventilation slot of the door included in the existing design. A latch base plate is included for mounting the hook guide with the hook, the mechanical linkage and the motor into a compact assembly unit.

In still another further aspect, a method of opening an appliance door includes providing an appliance having an electrically powered latch mechanism including a rotating hook for engaging a door of the appliance through a ventilation slot in the door. The electrically powered latch mechanism is operated to rotate the hook into engagement with the ventilation slot and thereby retain the door against the appliance in a closed position. A screwdriver is inserted into the ventilation slot to contact the engaged latch mechanism. The screwdriver is manually rotated to rotate the hook out of engagement with the ventilation slot and thereby release the door from the appliance. The door is then manually opened. The step of inserting the screwdriver can include inserting a flat blade screwdriver into a screwdriver slot in the latch mechanism such that rotation of the screwdriver causes the hook to move in a reverse direction, thereby manually rotating the hook out of engagement with the ventilation slot,

According to an aspect, the present invention provides an electrically powered latch for automatically securing an appliance door.

According to another aspect, the present invention provides a manual override for open an appliance door to gain access to the interior to inspect, remove items, etc. in the event of a power failure.

According to yet another aspect, the present invention provides a appliance door and latch that does not prevent access to interior by a disabled electrically powered latch that maintains the appliance door in a latched state which cannot be readily opened.

Other benefits and advantages of this invention will become apparent to those skilled in the art to which it pertains upon reading and understanding of the following detailed specification.

### III. BRIEF DESCRIPTION OF THE DRAWINGS

The disclosed hidden motorized latch assembly may take physical form in certain parts and arrangement of parts, embodiments of which will be described in detail in this specification and illustrated in the accompanying drawings which form a part hereof and wherein:

FIG. 1 is a perspective view of an oven appliance with a cutaway view including an encircled region depicting a hidden motorized door latch assembly in accordance with an exemplary embodiment.

FIG. 2 is a perspective view of the motorized latch assembly having a latching hook rod in the unlatched and retracted position in accordance with the exemplary embodiment.

FIG. 3 is a perspective view of the motorized latch assembly having the latching hook rod in the extended and rotated position in accordance with the exemplary embodiment.

FIG. 4 is an enlarged perspective view of the motorized latch assembly with the latching hook rod in the extended and rotated position and with a screwdriver being inserted into a slot feature for manual override of the latch in accordance with the exemplary embodiment.

FIG. 5 is an enlarged perspective view of the motorized latch assembly with the screwdriver rotated to decouple a latch linkage and to concurrently rotate and retract the latching hook rod in accordance with the exemplary embodiment.

FIG. 6 is an enlarged perspective view of the motorized latch assembly with the screwdriver withdrawn from the slot feature and with the latch linkage decoupled and the latching hook rod in the retracted position in accordance with the exemplary embodiment.

FIG. 7 is a perspective view of a motorized latch assembly in accordance with an alternative exemplary embodiment.

FIG. 8 is an exploded view of the motorized latch assembly in accordance with the alternative exemplary embodiment.

FIG. 9 is a reverse perspective view of the motorized latch assembly in a retracted, non-engaged operative state in accordance with the alternative exemplary embodiment.

FIG. 10 is a reverse perspective view of the motorized latch assembly in an extended and rotated, engaged operative state in accordance with the alternative exemplary embodiment.

FIG. 11 is an obverse perspective view of the motorized latch assembly in an extended and rotated, engaged operative state in accordance with the alternative exemplary embodiment.

FIG. 12 is a perspective view of a hook block assembly of the motorized latch assembly in accordance with the alternative exemplary embodiment.

FIG. 13 is an exploded view of the hook block assembly of the motorized latch assembly in accordance with the alternative exemplary embodiment.

FIG. 14 is a perspective view of a hook-guide assembly of the motorized latch assembly in accordance with the alternative exemplary embodiment.

FIG. 15 is an exploded view of the hook-guide assembly of the motorized latch assembly in accordance with the alternative exemplary embodiment.

FIG. 16 is an exploded obverse view of a hook block assembly of the motorized latch assembly in accordance with the alternative exemplary embodiment.

FIG. 17 is an exploded reverse view of the hook block assembly of the motorized latch assembly in accordance with the alternative exemplary embodiment.

FIG. 18 is a side sectional view of the hook block assembly depicting movement of the guide slot follower through the guide slot in accordance with the alternative exemplary embodiment.

FIG. 19 is an overhead view depicting a first operative state of a hook arm lobe with respect to a hook position switch of the motorized latch assembly in accordance with the alternative exemplary embodiment.

FIG. 20 is an overhead view depicting a second operative state of the hook arm lobe with respect to the hook position switch of the motorized latch assembly in accordance with the alternative exemplary embodiment.

FIG. 21 is a perspective view of an oven appliance including a cutaway view depicting a hidden motorized door latch assembly in accordance with the alternative exemplary embodiment.

FIG. 22 is a perspective view of the oven appliance depicting a method of manually unlatching an appliance door in the event of a power failure of the hidden motorized door latch assembly in accordance with the alternative exemplary embodiment.

FIG. 23 is a perspective view of an oven appliance including a cutaway view depicting the method of manually unlatching an appliance door in accordance with the alternative exemplary embodiment.

FIG. 24 is a closeup cutaway view of the oven appliance depicting a step in the method of manually unlatching an appliance door in accordance with the alternative exemplary embodiment.

FIG. 25 is a closeup cutaway view of the oven appliance depicting another step in the method of manually unlatching an appliance door in accordance with the alternative exemplary embodiment.

FIG. 26 is a perspective view of the oven appliance depicting the appliance door unlatched and open following the method in accordance with the alternative exemplary embodiment

### IV. DETAILED DESCRIPTION

Reference is now made to the drawings wherein the showings are for purposes of illustrating embodiments of the article only and not for purposes of limiting the same, and wherein like reference numerals are understood to refer to like components.

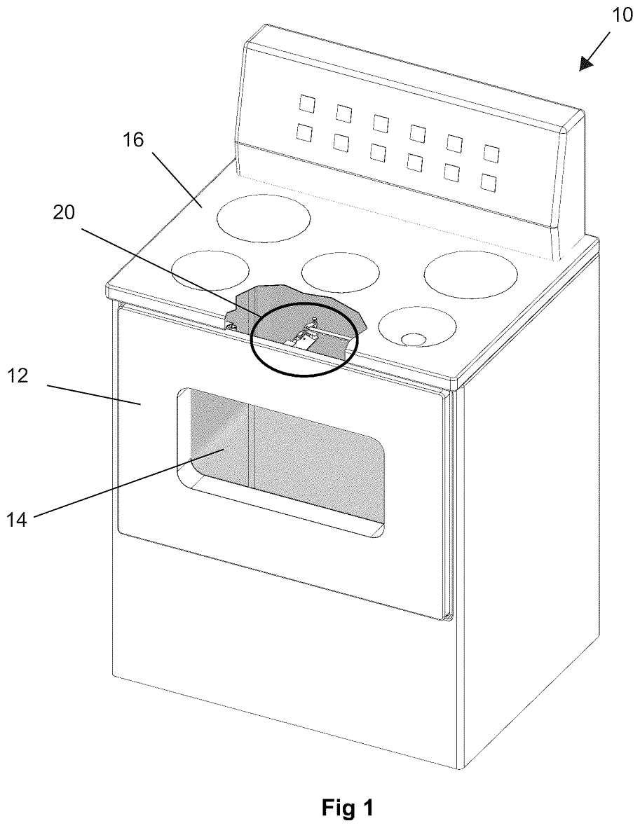

FIG. 1 depicts an oven appliance 10 having an appliance door 12 that pivots between an open and closed position as well known in the art. In the closed position the appliance door 12 encloses an oven area 14, visible behind a window in the door 12, for baking and other such cooking functions. The oven appliance 10 also includes a stove top 16 having the cutaway view.

The encircled region shown in FIG. 1 depicts a motorized door latch assembly 20 hidden underneath the stove top 16 which is configured for securing the door 12 in the closed position, thereby preventing opening of the door 12. The latch assembly 20 embodies an appliance latch having a latching hook rod 22 that retracts within the enclosure of the appliance 10 when not in use, thus making it hidden from operator view.

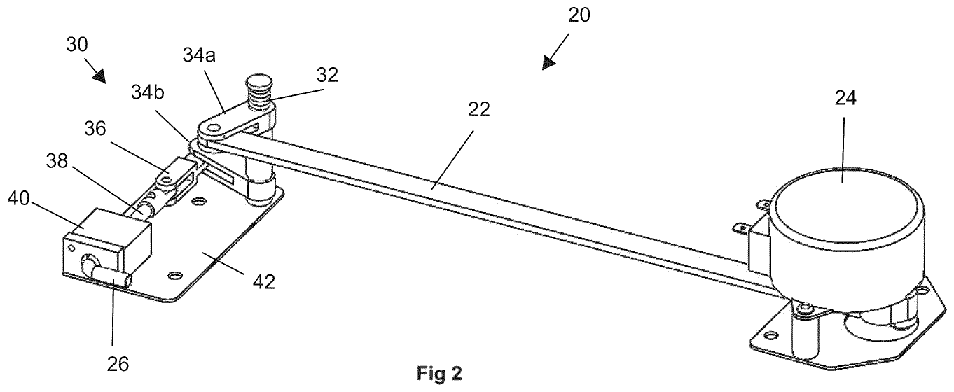

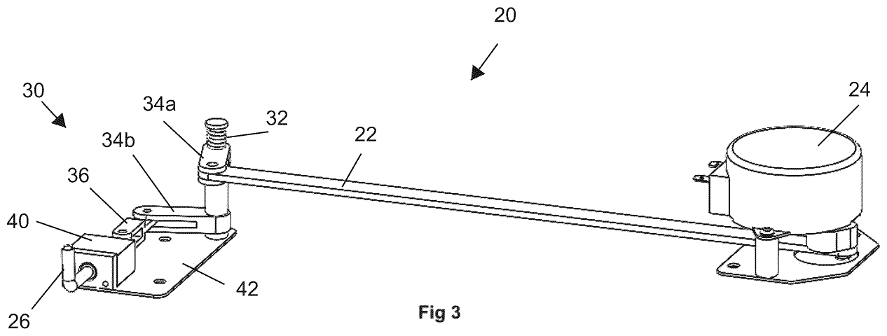

FIGS. 2 and 3 depict respective operative states of the motorized latch assembly 20 having a latching hook rod 22 which is displaced by a motor 24 and rotates a latch hook 26 between an unlatched position (horizontal) and a latched position (vertical). FIG. 2 depicts the latching hook rod 22 in the retracted position with the latch hook 26 correspondingly in the unlatched position (horizontal). FIG. 3 depicts the latching hook rod 22 in the extended position with the latch hook 26 rotated 90 degrees, or other predetermined angle, into a rotated, latched position (vertical).

With further reference to FIG. 3, when in use, such as during a self-cleaning cycle of the oven appliance 10, the latching hook rod 22 is extended by the motor 24 to engage a linkage 30 which is displaced by the latching hook rod 22 to rotate the latch hook 26 into the position that will latch the appliance door to prevent it from opening.

With further reference to FIGS. 2 and 3, an exemplary embodiment of the linkage 30 is described herewith, where it is to be appreciated that the operative function could be accomplished any other suitable configuration of components without departing from the present invention. The linkage 30 includes a vertical post 32 which is configured for rotation about a vertical axis by the latching hook rod 22. A first linkage component 34a is securely mounted to the vertical post 32. The first linkage component 34a is rotatably connected to an end of the latching hook rod 22 opposite the motor 24. The first linkage component 34 is connected to the latching hook 22 at a displaced point on the first linkage component 34a extending away from the vertical post 32. In this manner, the first linkage component 34a is configured such that a horizontal displacement of the latching hook rod 22 translates into a rotational movement of the vertical post 32.

With ongoing reference to FIGS. 2 and 3, a second linkage component 34b is also securely mounted to the vertical post 32 and displaced at a predetermined angle of rotation around the vertical axis from the first linkage component 34a (e.g., 90 degrees). The second linkage component 34b is rotatably connected to an end of a universal joint 36 at a displaced point on the second linkage component 34b extending away from the vertical post 32. In this manner, the second linkage component 34b is configured such that a rotational displacement of the vertical post 32 resulting from the first linkage component 34a rotates the second linkage component 34b which in turn produces a linear displacement of the universal joint 36 in a forward direction toward the appliance door 12 at the front of the oven appliance 10.

With further ongoing reference to FIGS. 2 and 3, the universal joint 36 is cooperatively connected to a shaft 38 formed integrally with the latching hook 22. The shaft 38 runs through a guide block 40, which is securely connected to a mounting plate 42. The vertical post 32 is also securely connected to the mounting plate 42. The mounting plate 42 is in turn bolted or otherwise securely connected to a structural component within the oven appliance 10, so that the mounting plate 42 and all the components of the linkage 30 are securely mounted to the oven appliance 10.

With additional ongoing reference to FIGS. 2 and 3, the shaft 38 can preferably include first and second threaded portions. A slot follower formed on shaft 38 engages a second mating guide slot formed within the guide block 40 . . . . Upon the linear displacement of the universal joint 36, in the forward direction toward the door 12 at the front of the oven appliance 10, the linear displacement upon the shaft 38 causes the shaft 38 to rotate such that guide follower on the shaft 38 follows the guide slot in the guide block 40 so that the latch hook 26 rotates from the unlatched position (horizontal) shown in FIG. 2 to the latched position (vertical) shown in FIG. 3. In this manner, by displacing the latching hook rod 22 through the components of the linkage 30, the latch hook 26 is rotated into the position that will latch the appliance door 12 to prevent it from opening.

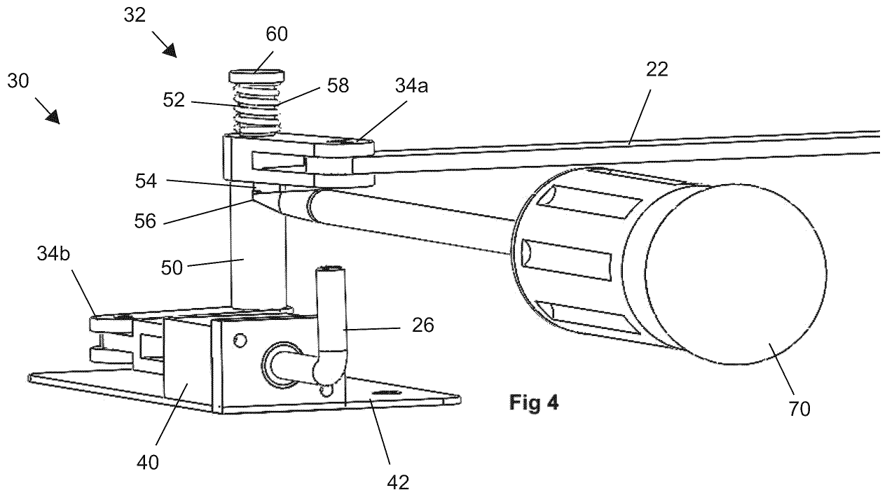

Reference is now made to FIGS. 4, 5, and 6, in which the door latch assembly 20 of the present invention includes a manual override feature that allows an appliance user or operator or a service technician to decouple the latch linkage 30 during power outages and other situations that may require opening of the appliance door 12 when the latch hook 26 is engaged. The manual override feature can be accomplished by using a screwdriver (preferably a flat head screwdriver) that is inserted through an access opening above or adjacent to the appliance door 12 in order to interact with the vertical post 32 of the linkage 30.

With further reference to FIGS. 4, 5, and 6, the vertical post 32 includes an outer sleeve 50 which is a rotating member that circumferentially encircles and encloses over a stationary central shaft 52, fixedly mounted to the mounting plate 42. The central shaft 52 is nested within the outer sleeve 50 and capable of free rotational movement therewithin. The outer sleeve 50 is securely connected to the second linkage component 34b such that rotation of the outer sleeve 50 results in corresponding rotation of the second linkage component 34b. The first linkage component 34a is configured to slide freely upon the central shaft 52 and be urged into secure engagement with the outer sleeve 52 so that the first linkage component 34a can rotate together with the outer sleeve 52 and thus with the second linkage component 34b.

With ongoing reference to FIGS. 4, 5, and 6, a tab 54 is formed onto the bottom of the first linkage component 34a such that the tab 54 is received within a notch 56 formed into the top of the outer sleeve 40. A biasing spring 58 is configured to press against a cap 60 atop the central shaft 52 in order to urge the first linkage component 34a into engagement with the outer sleeve 52 such that the tab 54 is securely received within the notch 56. In this manner, the first linkage component 34a is configured to rotate together with the outer sleeve 50 and the second linkage component 34b in response to movement of the latching hook rod 22 as described hereinabove.

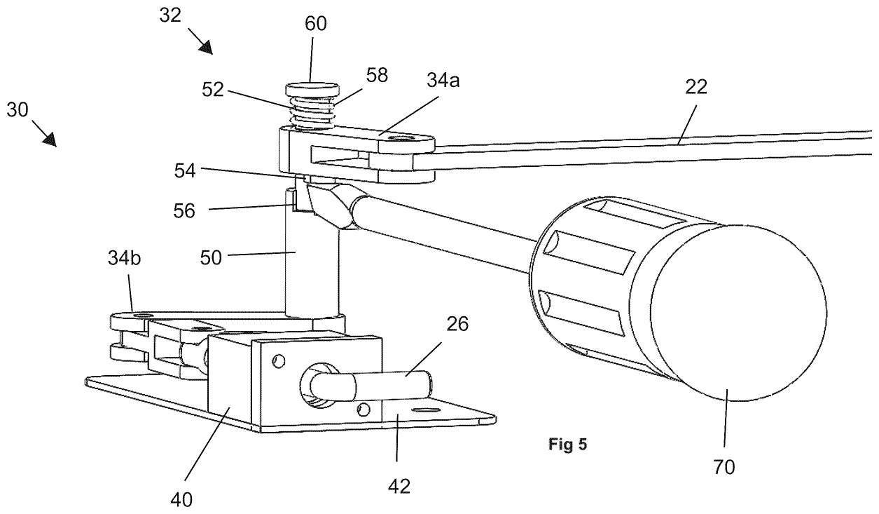

With specific reference to FIG. 4, the manual override feature is accomplished by inserting the screwdriver 70 into the notch 56, and under the tab 54. With specific reference to FIG. 5, a clockwise rotation of the screwdriver 70 causes an upper edge 72 of the screwdriver 70 to press upwardly against the tab 54, displacing the first linkage component 34a upwardly along the central shaft 52, compressing the biasing spring 58 and disengaging the tab 54 from the notch 56. A tab notch 54a formed into a bottom left corner of the tab 54 is configured to receive and engage the upper edge 72 of the screwdriver 70 in order to rotate the first linkage component 34a and thereby displace the latching hook rod 22 into the extended and rotated position depicted in FIG. 3.

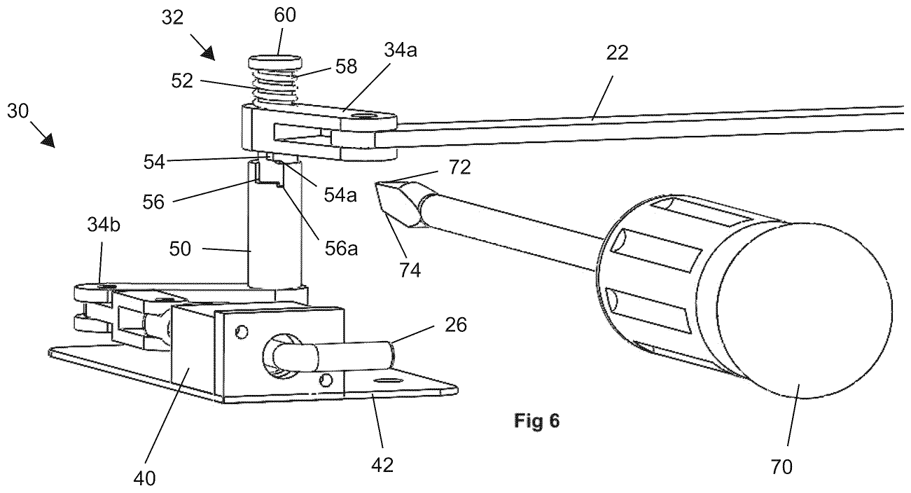

As particularly shown in FIGS. 5 and 6, conversely, a subnotch 56a of the notch 56 is configured to receive and engage a lower edge 74 of the screwdriver 70, thereby causing concurrent rotation of the outer sleeve 50 and the second linkage component 34a in the opposite direction from the rotation of the first linkage component 34a, thereby displacing the latch hook 26 into the unlatched position (horizontal) depicted in FIG. 2. In this aforementioned manner, the tab notch 54a and the subnotch 56a provide leverage surfaces against which the upper and lower edges 72, 74 of the screwdriver 70 can act in order to operatively decouple and separate the first linkage component 34a from the rest of the linkage 30 and disengage the latch hook 26 allowing release of the appliance door 12.

In the foregoing manner, the manual override feature enables a spring biased coupling within the linkage 30 to be decoupled and thus disengaged, enabling the door 12 to be opened by the appliance user, for example, in the event of a power failure. The manual override feature thus enables concurrently opposite rotations of the decoupled linkage components and accompanying rotation of the latching hook rod 22 and subsequent retraction of the latching hook rod 22 to its retracted and hidden position; thus, allowing the appliance door to be opened. When power is returned to the appliance, the appliance controller component will then supply power to the motor 24 which will automatically rotationally reengage the aforementioned coupling components, thus resetting the appliance latch for future use.

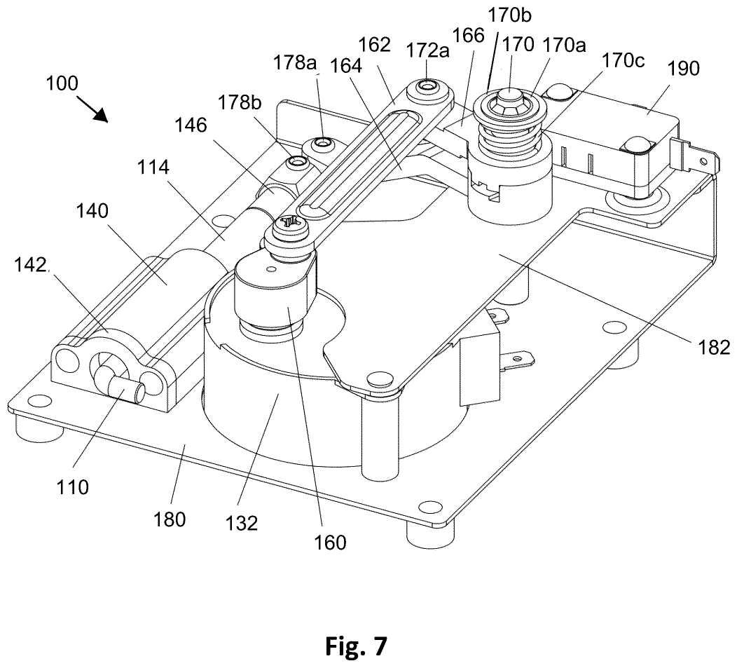

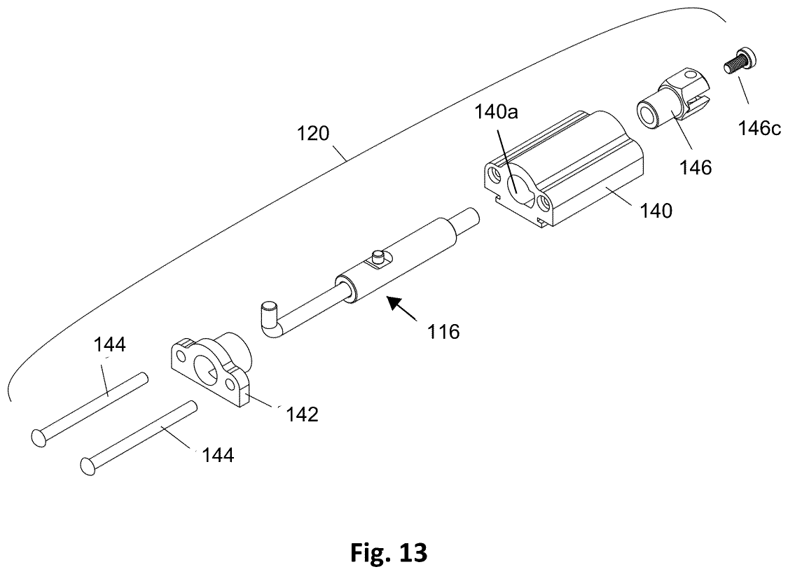

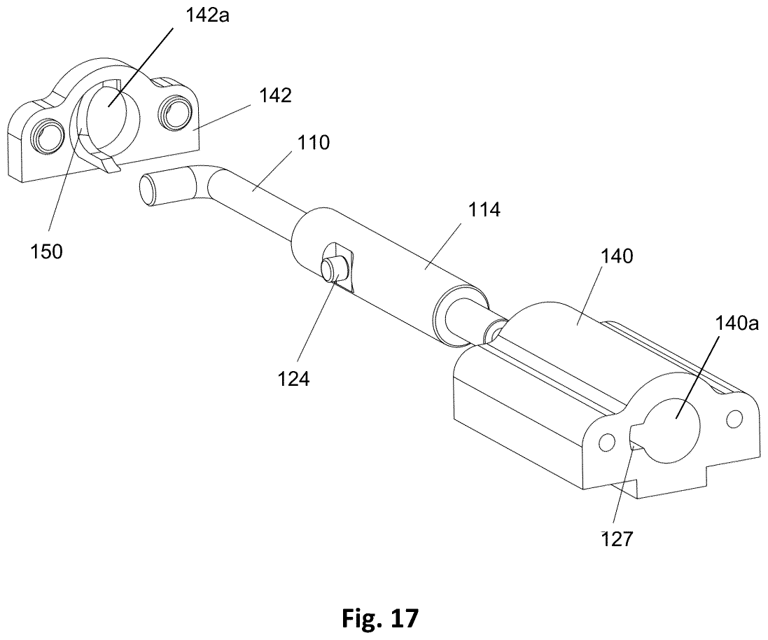

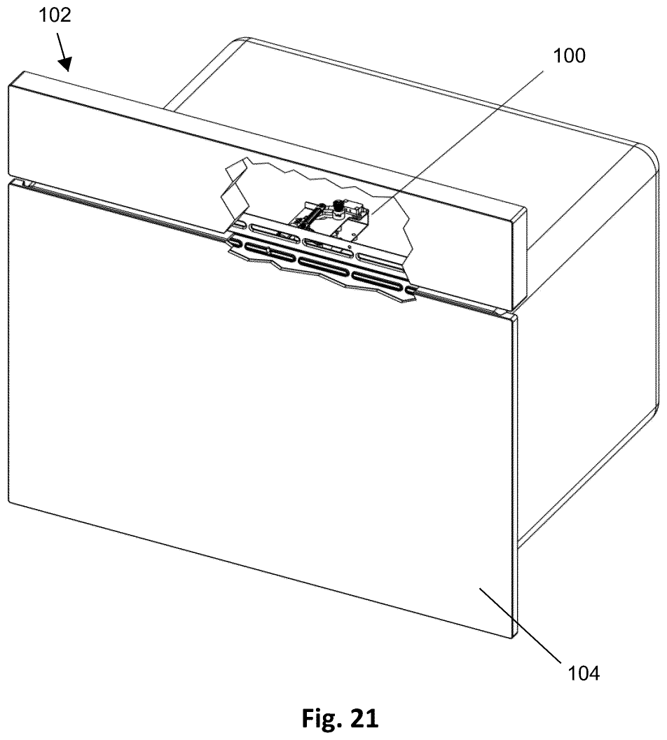

Reference is now made to FIGS. 7-26 which depict an alternate embodiment of a motorized latch assembly 100. In particular, FIG. 7 shows the motorized latch assembly 100 embodied as a hidden latch assembly 100 with a manual override feature. The hidden latch 100 is configured for use with an appliance 102 (for example, an oven 102 (e.g., a wall oven as depicted in FIGS. 21-26)) in order to secure a door 104 of the appliance 102. A general description of the latch assembly 100 and its operation is provided initially, followed by a specific description of the individual components.

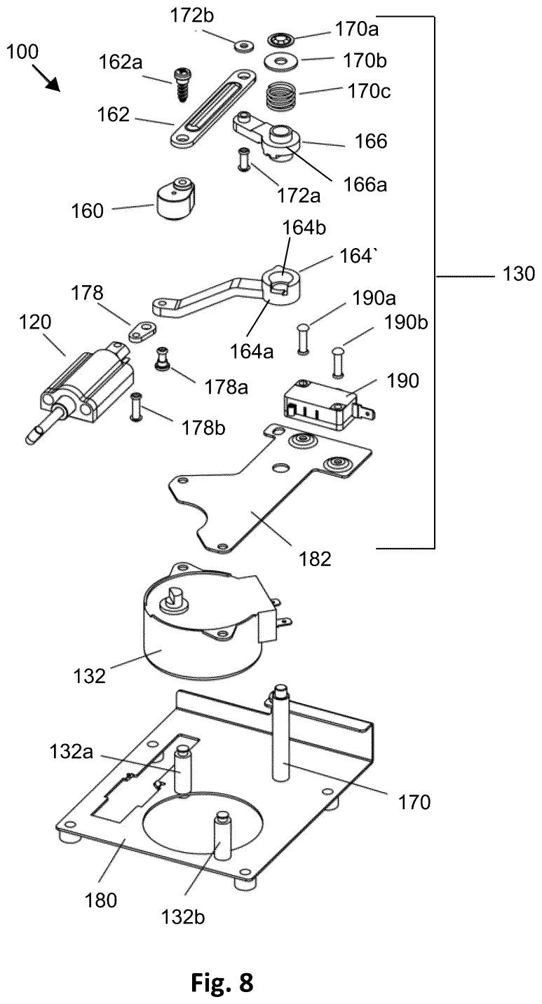

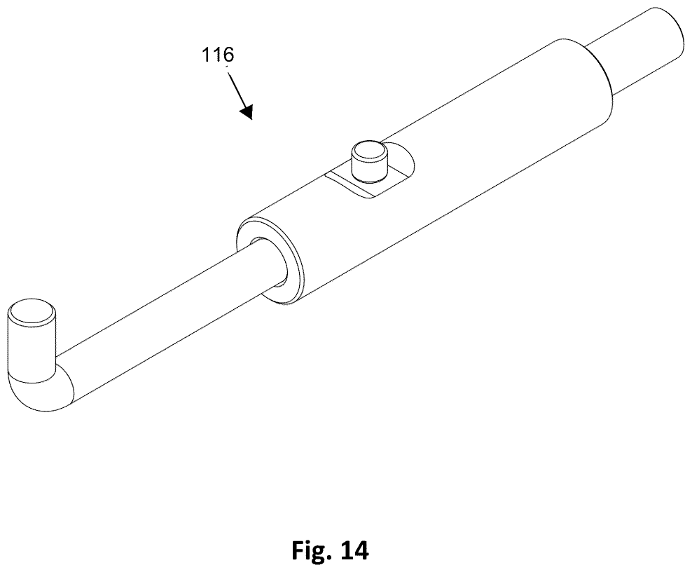

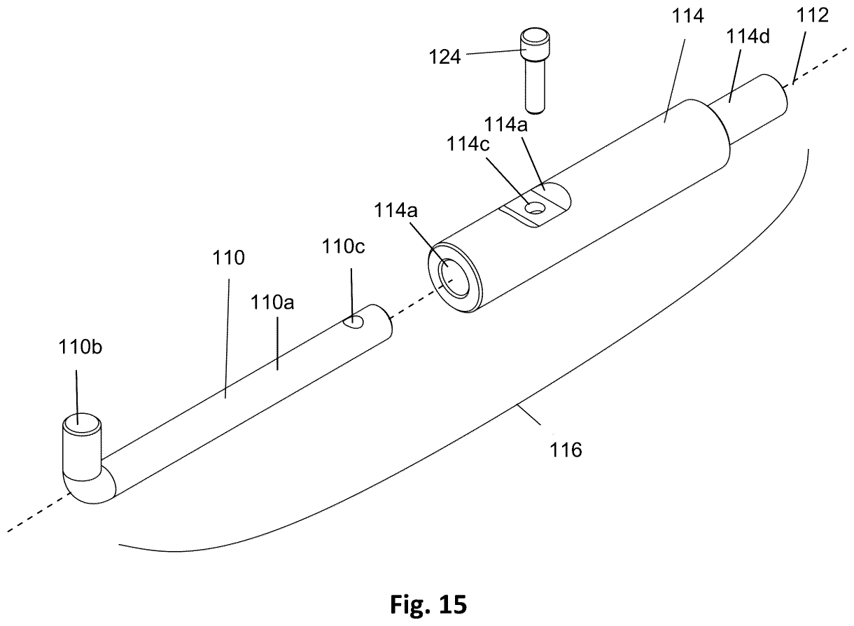

With specific reference to FIGS. 7 and 8, the hidden latch assembly 100 includes a hook 110 for securing the door 104 of the appliance 102 in a closed position. As depicted in FIG. 15, the hook 110 includes a generally cylindrical hook shaft 110a extending along a longitudinal cylinder axis 112 and a hook end 110b configured at an angle to the longitudinal axis 112, preferably a 90 degree angle. A hook guide 114 is provided for receiving and retaining the hook 110. Preferably, the hook guide 114 is generally cylindrical, having a greater diameter than the hook 110, and including a cylindrical axial bore 114a for receiving the cylindrical hook shaft 110a. The hook guide 114 is configured to engage the hook shaft 110a for rotation upon linear advancement in the direction of the longitudinal axis 112. The hook 110 and hook guide 114 are fitted together to form a hook guide assembly 116 as depicted in FIGS. 14 and 15.

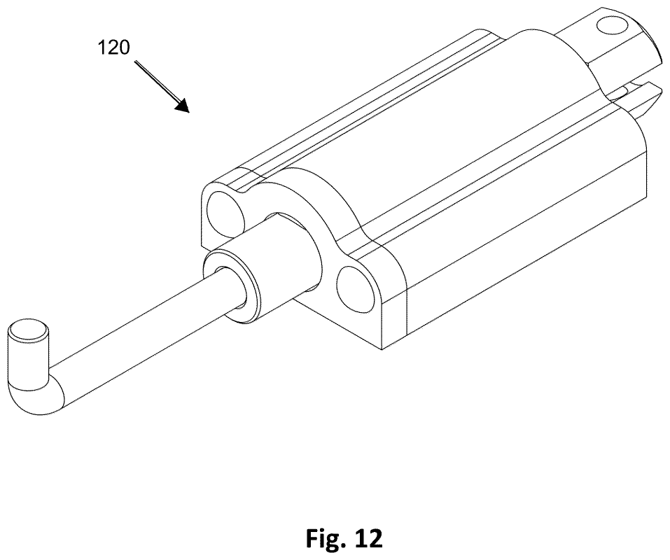

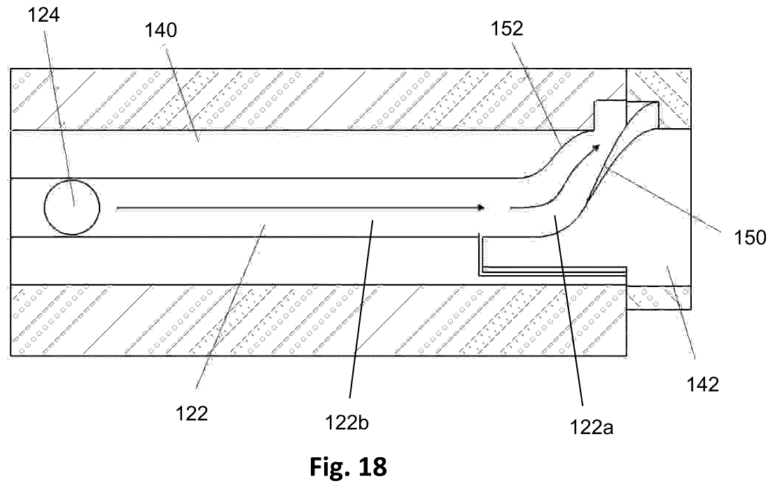

With ongoing reference to FIGS. 7 and 8, and additionally FIGS. 12, 13, and 16-18, a hook block assembly 120 is provided for receiving and retaining the hook guide assembly 116. The hook block assembly 120 includes an internal guide slot 122 configured to engage a guide slot follower 124 protruding from the hook shaft 114. As depicted in FIG. 18, the guide slot 122 includes a helical portion 122a for guiding the guide slot follower 124 into rotation of the hook 110 along a predetermined rotational angle upon linear advancement of the hook 110 in the direction of the longitudinal axis 112.

With further ongoing reference to FIGS. 7 and 8, and additionally FIG. 2, the hidden latch assembly 100 also includes a mechanical linkage 130 connected to the hook 110 for transmitting the linear advancement to the hook 110 from an electrical motor 132. An engagement surface is configured to receive the hook end 110b upon rotation of the hook 110. The engagement surface and the hook end 110b are configured for the securing of the door to the appliance in the closed position. The engagement surface 104a is preferably an engagement slot 104a of the oven door 104 of the wall oven 102 as shown in FIGS. 21-26 configured to receive the hook end 110b upon rotation, for securing the door of the oven 102 in the closed position.

Having initially provided the general description of the latch assembly 100 and its operation, the specific description of the individual components follows herewith.

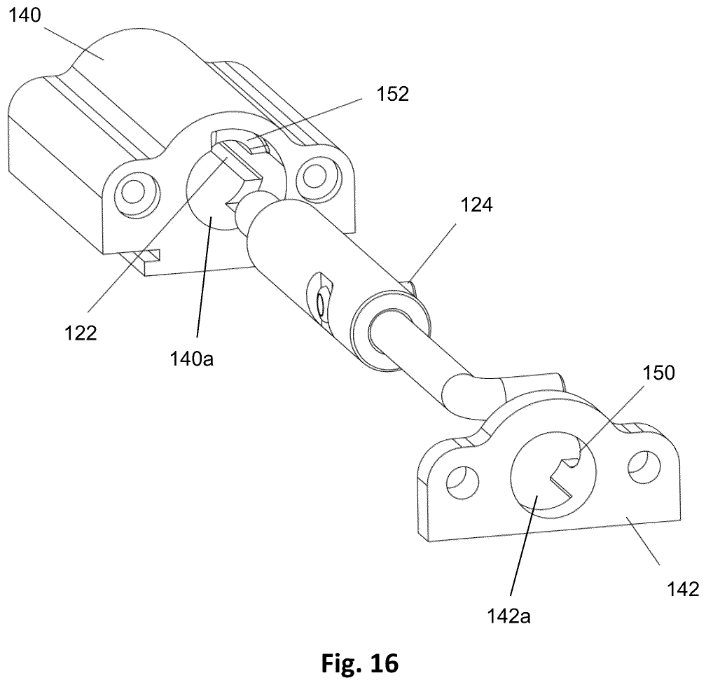

As shown in FIG. 15, the guide slot follower 124 is a cylindrical pin extending perpendicularly from the hook guide 114. This perpendicular guide slot follower 124 is thus configured to internally engage the guide slot 122 as shown in FIG. 16. The guide slot follower 124 is received onto a seat surface 114b inside a bore 114c of the hook guide 114, and can connect into a mating bore 110c of the hook shaft 110. The hook 110, hook guide 114 and guide slot follower 124 are fitted together to form the assembled hook guide assembly 116 as depicted in FIG. 14.

As especially shown in FIGS. 12, 13, 16, and 17, the hook guide assembly 116 is received within the hook block assembly 120 and moves freely therewithin to translate linear displacement of the entire hook guide assembly 116 into rotation. The hook block assembly 120 includes a guide block 140 matingly connected to a guide block cap 142 via a pair of guide block rivets 144. The guide block 140 and the guide block cap 142 include an internal bore 140a, 142a for receiving and retaining the hook guide assembly 116. The guide slot 122 is defined by a channel formed within a surface of the internal bore 140a, 142a of the guide block 140 and the guide block cap 142 of the hook block assembly 120. A guide swivel 146 is received within a distal end of the internal bore 140a of the guide block 140 and includes an internal bore for mating with a cylindrical tapered end 114d of the hook guide 114. A guide swivel screw 146a secures the guide swivel 146 to the tapered end 114d.

As particularly shown in FIGS. 16, 17, and 18, the guide slot 122 includes a longitudinal portion 122b parallel to the longitudinal axis 112 for linearly guiding the guide slot follower 124. As the hook 110 and the hook guide assembly 116 are linearly displaced, the guide slot follower 124 moves linearly through the longitudinal portion 122b. The longitudinal portion 122b connects with the helical portion 122a, thereby causing the guide slot follower 124 to move helically around the longitudinal axis 112, thereby resulting in the rotation of the hook 110 and the hook guide assembly 116.

With ongoing reference to FIGS. 16, 17, and 18, the guide block cap 142 includes an extension guide ramp 150 that extends into the internal bore 140a of the guide block 140. The extension guide ramp 150 includes a sloped contact surface of the helical portion 122a for guiding the guide slot follower 124 into rotation upon extension of the hook 110. The predetermined rotational angle of the helical portion 122a preferably extends 90 degrees or other predefined angle, to effect a turn of rotation of the hook end 110b into the engagement slot 104a, thereby securing the oven door 104 in the closed position. The guide block 140 includes a retraction guide ramp 152 matingly connected to the extension guide ramp 150. The retraction guide ramp 152 includes a mating contact surface of the helical portion 122a for guiding the guide slot follower 124 upon retraction of the hook 110. As the hook guide assembly 116 is linearly withdrawn to release the hook 110 from engagement, the guide slot follower 124 encounters the retraction guide ramp 152 and moves helically around the longitudinal axis 112 in the reverse direction, thereby reversing the rotation of the hook 100 and the hook guide assembly 116.

Turning now to FIGS. 7-11, the mechanical linkage 130 includes components that transmit displacement from the electrical motor 132 to the hook guide assembly 116 to transform the linear advancement into rotation of the hook 110 as described hereinabove. The mechanical linkage 130 includes a motor crank arm 160 in connection with the motor 132. The motor crank arm 160 is shaped in order to attach eccentrically to a link bar 162. A hook arm 164 and a link arm 166 are moveably conjoined for common reciprocal motion about a pivot post 170. The link bar 162 is connected to the link arm 166 and the hook arm 164 is connected to the hook guide 144.

With continuing reference to FIGS. 7-11, the construction and operation of the hidden latch assembly 100 and the mechanical linkage 130 are described in detail herewith The link bar 162 and the motor crank arm 160 are secured together with a link bar screw 162a. Rotation of the motor 132 eccentrically rotates the motor crank arm 160 which linearly displaces the link bar 162. The link arm 166 and the link bar 162 are pivotally connected with a pivot pin 172a and washer 172b such that linear displacement of the link bar 162 pivots the link arm 166. The hook arm 164 is configured to conjoin and moveably mate with the link arm 166. Both the hook arm 164 and link arm 166 have cylindrical ends 164a, 166a that each include mating profile features that define a screwdriver slot 174 used for the manual override, as explained in the method below. The mating profile features include a notch 164b formed in the hook arm cylindrical end 164 that mates with a protrusion 166b of the link arm cylindrical end 166a with a gap therebetween that defines the screwdriver slot 174.

With continuing reference to FIGS. 7-11 describing the construction and operation of the hidden latch assembly 100 and the mechanical linkage 130, the pivot post 170 receives and retains the hook arm 164 and the link arm 166 along central bores through each cylindrical end 164a, 164b. The pivot post 170 has a pivot axis around which the cylindrical ends 164a, 166a pivot. The hook arm 164 and the link arm 166 are thus coaxially mounted together along the pivot post 170 by a retaining ring 170a, a washer 170b, and a compression spring 170b which urges the hook arm 164 and link arm 166 into moveable contact. The hook arm 164 is connected to the guide swivel 146 through a hook arm link 178 which is formed as a flat plate with a pair of holes for receiving pivot pins 178a, 178b for respectively pivotally connecting the hook arm 164 to the guide swivel 146.

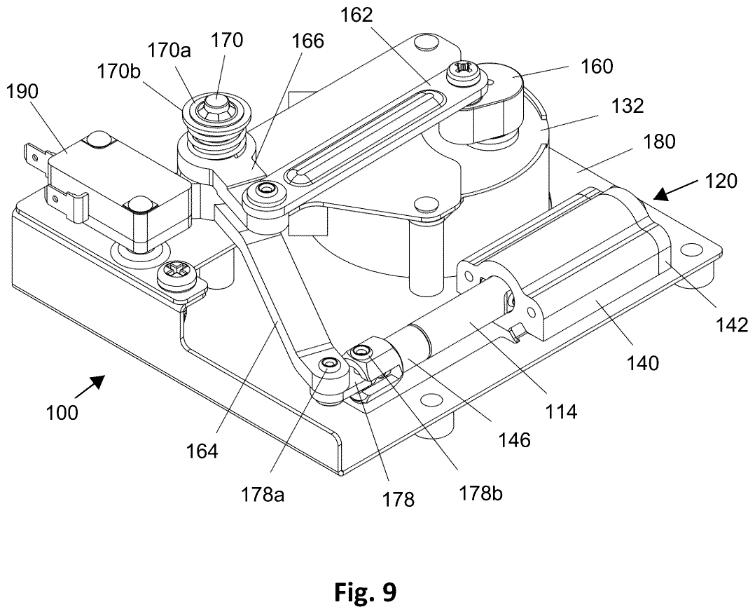

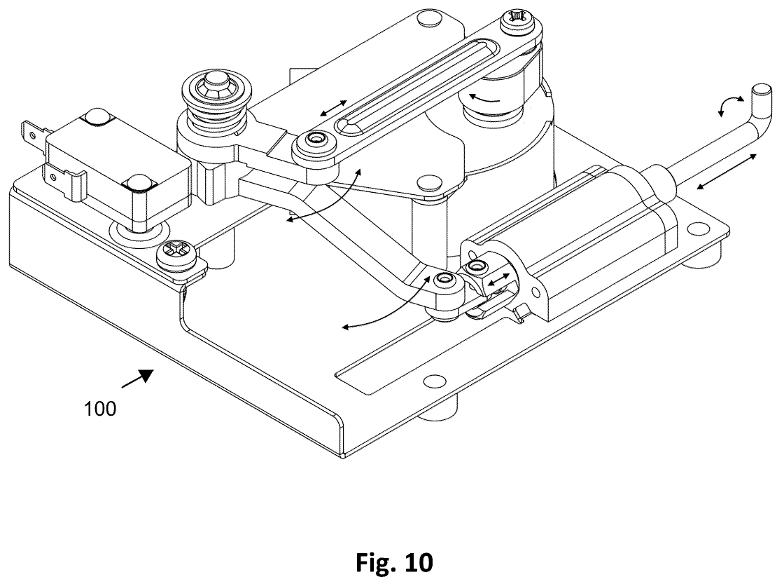

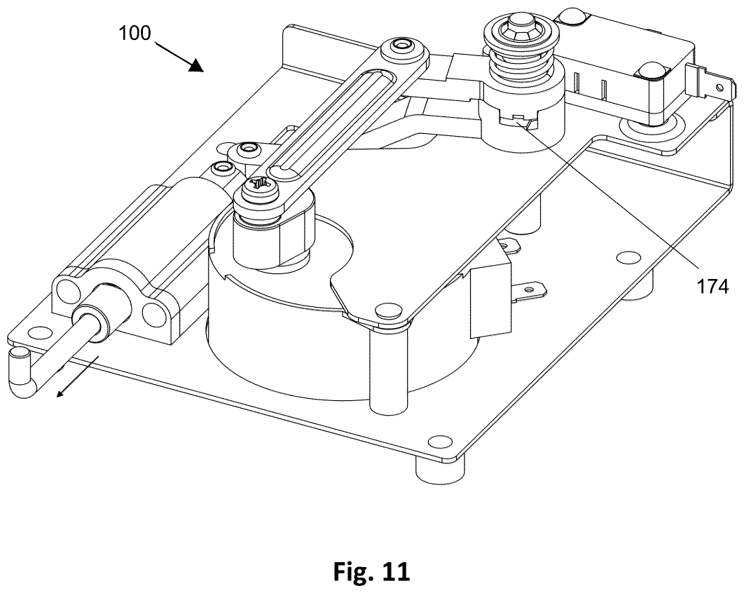

With continuing reference to FIGS. 7-11 describing the construction of the hidden latch assembly 100 and the mechanical linkage 130, the operation of the motor 132 rotates the crank arm 160 which linearly displaces the link bar 162 which then pivots the link arm 166 together with the hook arm 164 about the pivot post 170. The pivoting of the hook arm 164 in turn displaces the hook guide assembly 116 such that the linear advancement is transmitted to the hook 110 by rotation of the motor 132. As shown in FIGS. 7 and 9, the motorized hidden latch assembly 100 is in a retracted, non-engaged operative state with the hook 100 withdrawn. FIGS. 10 and 11 show the motorized hidden latch assembly 100 in an extended, engaged operative state. Activation of the motor 132 rotates the crank arm 160 which withdraws the link bar 162 toward the motor 132. This then rotates the link arm 166 and hook arm 164 counterclockwise, thereby pushing upon the hook guide assembly 116 to linearly displace the hook guide 114 so that the guide slot follower 124 follows the helical path to rotate the hook end 110b.

With particular reference to FIGS. 7 and 8, a latch base plate 180 is provided for mounting the pivot post 170, which extends vertically upward from the base plate 180 to receive the cylindrical ends 164a, 166a and the other aforementioned components of the mechanical linkage 130. The base plate 180 also mounts the other components of the hidden latch assembly 100 including the hook block assembly 120 that retains the hook guide assembly 116 with the hook 110. The motor 132 is mounted to the latch base plate 180 between a pair of vertically extending motor mounting posts 132a, 132b. The motor 132 is retained between the latch base plate 180 and a switch mounting plate 182 which sits atop the motor 132 and provides a support surface for the cylindrical ends 164a, 166a. The switch mounting plate 182 also mounts a hook position switch 190 using a pair of switch rivets 190a, 190b. In the aforementioned manner, the latch base plate 180 provides a mounting structure that results in a compact assembly unit that can be installed in the appliance 102. These aforementioned features are easily formed in components manufactured by processes such as powdered metallurgy, die casting, injection molding, and other similar processes, thus making the manufacturability of the exemplary features of the present latch 100 cost effective.

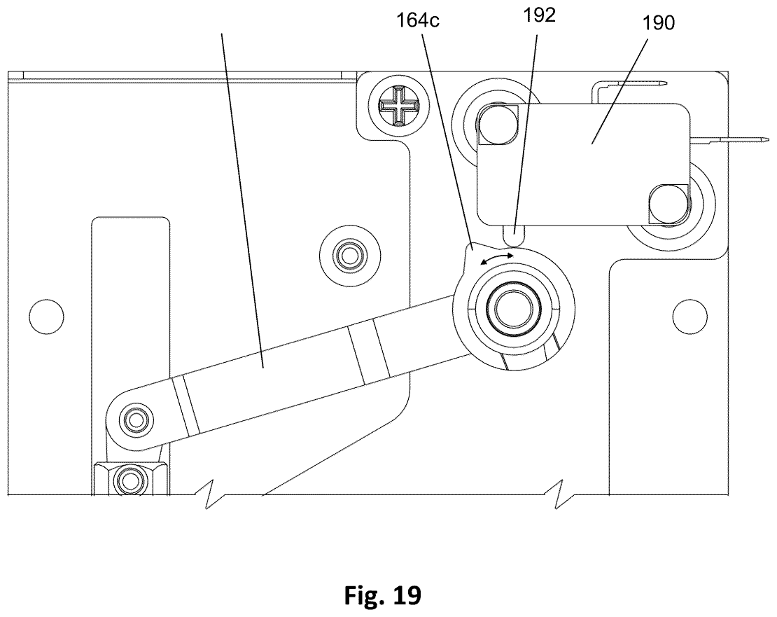

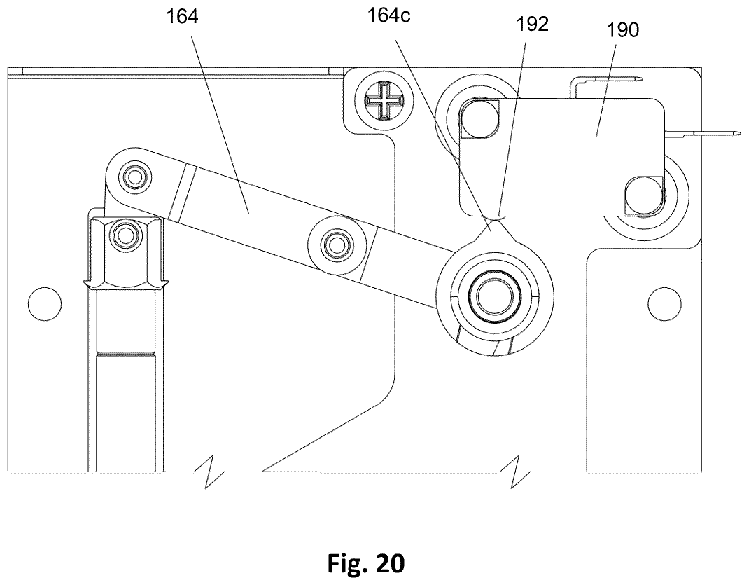

Turning now to FIGS. 19 and 20, the hook position switch 190 is electrically interfaces with the appliance's controller (not shown) which controls the motor 132 and used to disconnect the operation of the motor 132 upon retraction of the hook 110 to open the appliance 102. The pivot post 170 includes a hook arm lobe 164c, a protrusion formed at a specific position on the cylindrical end 164a of the hook arm 164. FIG. 19 shows the latch 100 in the an extended, engaged operative state in which the hook arm lobe 164c is displaced from the hook position switch 190. Upon reversing the motor 132 to reverse the latch 100 to the retracted, non-engaged operative state, as shown in FIG. 20, the cylindrical end 164a rotates clockwise through a predetermined angle of rotation (about 30 degrees) to move the hook arm lobe 164c into contact with a switch button 192 of the hook position switch 190. Engagement of the hook arm lobe 164c and the switch button 192 generates a signal to the appliance's controller to discontinue the motor 132 and the linear advancement of the mechanical linkage 130.

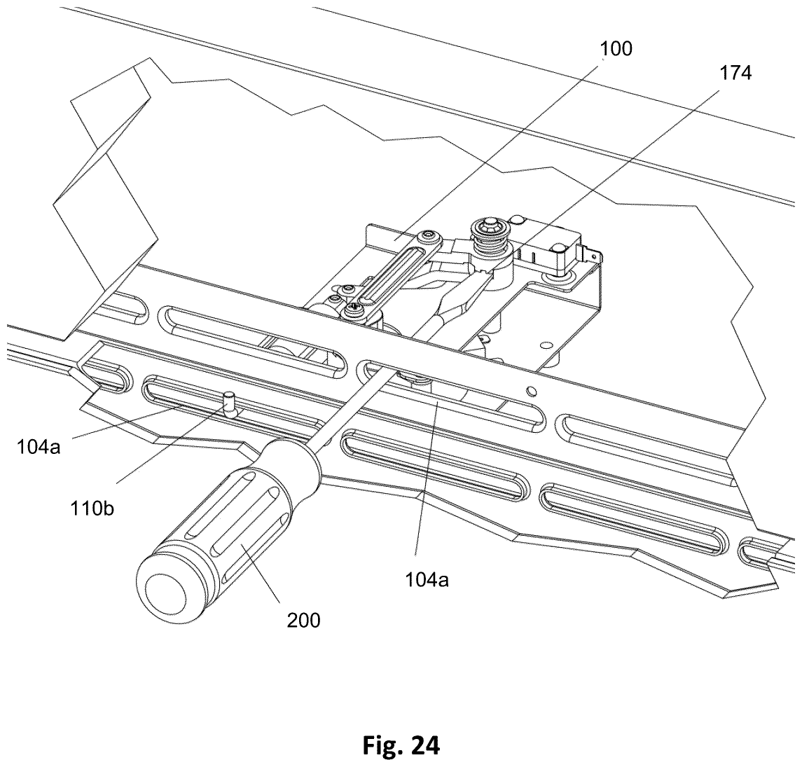

As shown in FIGS. 21-26, the present hidden latch assembly 100 can be mounted onto the appliance such as a wall oven 102 of an existing design. In this manner, the present latch 100 can be incorporated into a current product line and/or retrofitted into products currently in use in the homes of customers. As shown in FIG. 24, the engagement slot 104a can be a ventilation slot of the oven door 104 included in the existing design. In the extended, engaged operative state, the hook end 100b extends through an oven chassis slot 102a of the wall oven 102 and extends further beyond to the ventilation slot 104a of the door 104.

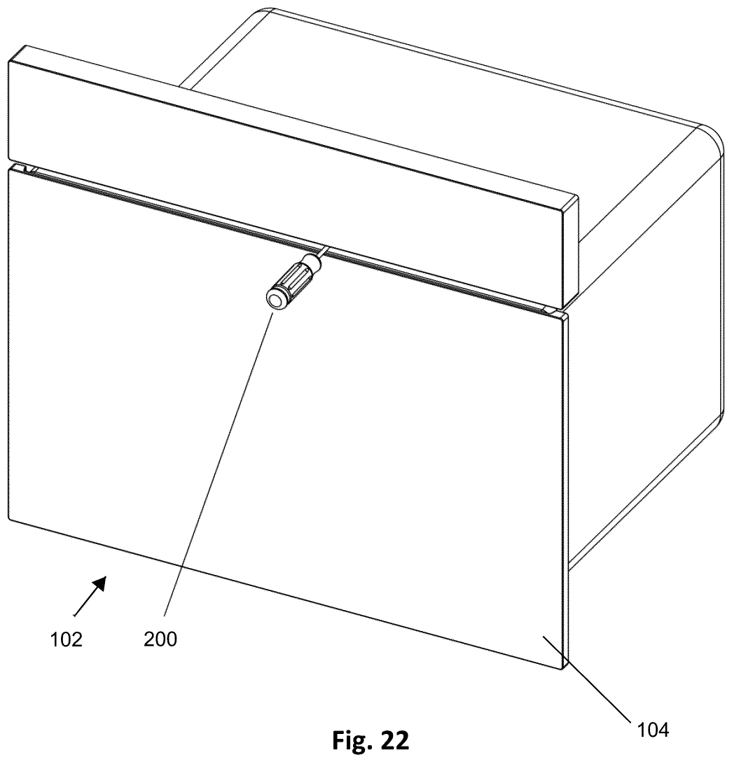

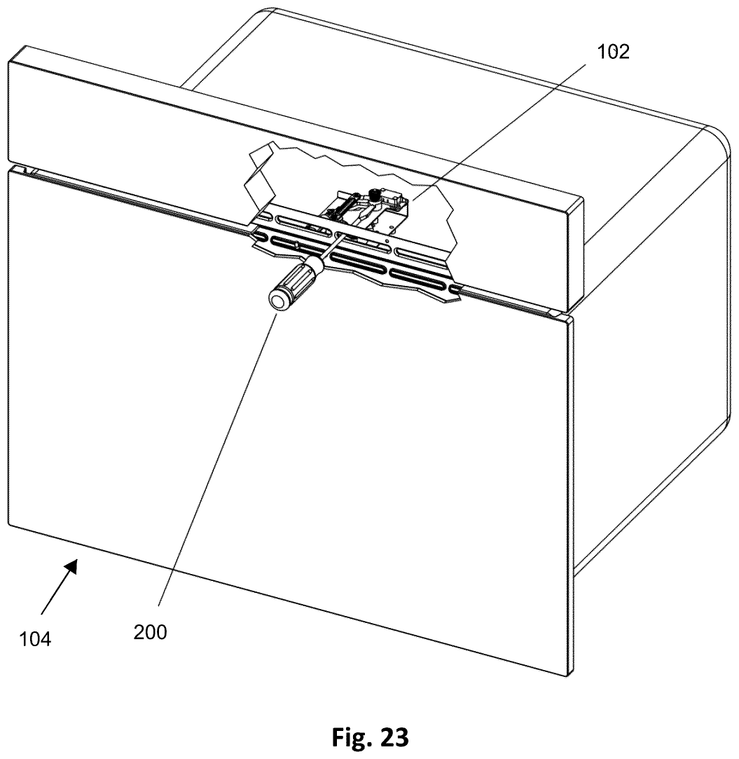

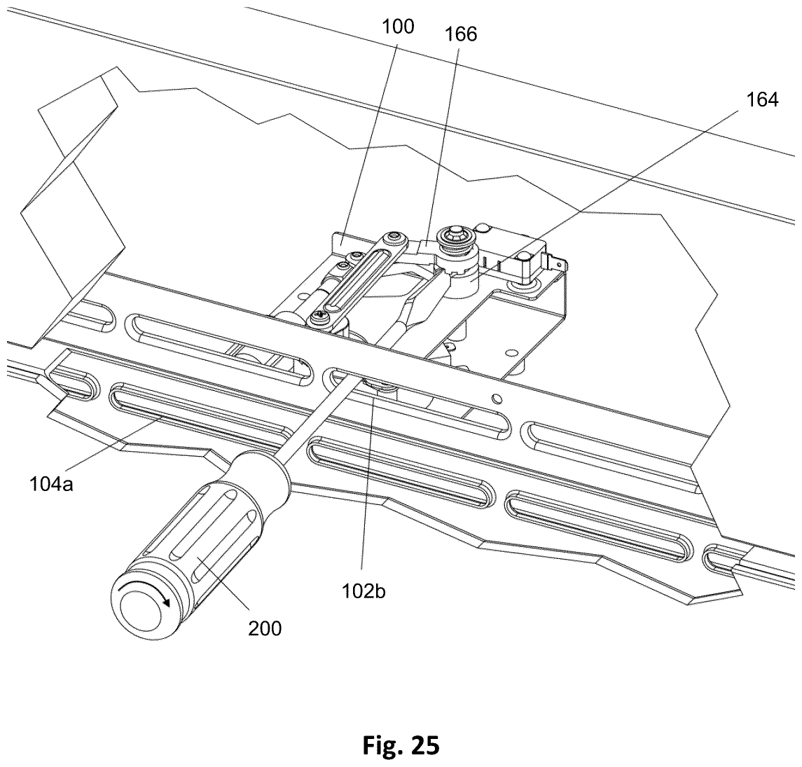

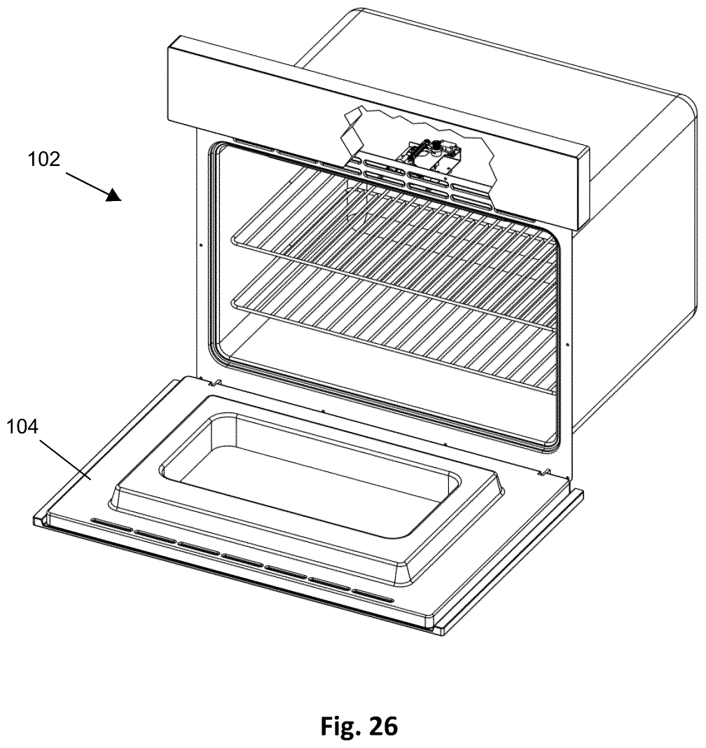

A method of operation including a manual override feature is now described herewith in connection with the appliance 102 shown in FIGS. 21-26. The appliance (e.g., the wall oven 102) is provided having the electrically powered hidden latch mechanism 100 that includes the rotating hook 110 for engaging the door 104 of the oven 102 through the ventilation slot 104a in the door 104. The electrically powered latch mechanism 100 is operated to rotate the hook 110 into engagement with the ventilation slot 104a and thereby retain the door 104 in secure connection against the appliance 102 in a closed position. As shown in FIGS. 22 and 23, a flat blade screwdriver 200 is inserted into the ventilation slot 104a to contact the engaged latch mechanism 100. In particular, as shown in FIG. 24, the flat blade screwdriver 200 is inserted into the screwdriver slot 174 defined by the gap between the cylindrical ends 164a, 166a. As shown in FIG. 25, an approximately quarter turn rotation of the screwdriver 200 urges the cylindrical ends 164a, 166a apart by exerting a force against the compression spring 170c. The mating profile features come apart under this force, including the protrusion 166b of the link arm cylindrical end 166a which comes apart from the notch 164b in the hook arm cylindrical end 164a. The force of the rotation of the screwdriver 200 then causes the hook arm 164 to move in the reverse direction, linearly withdrawing the hook guide assembly 116 and thereby manually rotating the hook 110 out of engagement with the engagement slot 104a, thus releasing the door 104 from the appliance 102. The door 104 can then be manually opened as shown in FIG. 26.

In the foregoing manner, the apparatus and method of the present invention provides a latch 100 with a mechanism including a manual override feature that is operated by the insertion and rotation of a common flat blade screwdriver. This eliminates the need for a special tool for manually opening the oven door 104. The override can be performed by a homeowner, thus, eliminating the need for a service call in the event of an electrical outage or a component failure. The latch 100 with the hook 110 that extends and retracts through the existing ventilation slot 104a in the oven chassis and engages an existing ventilation slot 104a in the oven door 104 eliminates the need for additional latch-specific openings in the oven chassis or door; thus, keeping the appearance of the oven uniform and pleasing. The hook 110 retracts well behind the oven chassis slot and into the shadows of the oven chassis making it unnoticeable, providing further desirable features.

In the preferred embodiment, there are two groupings of ventilation slots 104a; one grouping is in the door 104 and another grouping is in the chassis of the oven above the oven cavity. One or both of these groupings becomes aligned for effective forced ventilation when the door 104 is closed. This alignment also creates a passageway for the hook 110 to extend through both chassis and door slots 104a. (For reference, the door and chassis slots 104a are clearly shown on FIGS. 23-26). Thus, the latch hook 100 is “hidden” insofar as it retracts behind the face of the oven chassis slot 104a to the extent that it is essentially hidden from view when the door 104 is open, in contrasts to prior art oven latches in which the hook is visible when the door 104 is open.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A latch assembly, comprising:
a hook for securing a door of an appliance in a closed position, wherein the hook comprises a hook shaft extending along a longitudinal axis and a hook end configured at an angle to the longitudinal axis;
a hook guide for receiving and retaining the hook and configured to engage the hook shaft for rotation upon linear advancement in the direction of the longitudinal axis;
a mechanical linkage connected to the hook guide for transmitting the linear advancement to the hook from a motor; and
an engagement surface configured to receive the hook end upon rotation, wherein the engagement surface and the hook end are configured for the securing of the door to the appliance in the closed position.

2. The latch assembly of claim 1, further comprising a hook block assembly for receiving and retaining the hook guide, wherein the hook block assembly comprises an internal guide slot configured to engage a guide slot follower protruding from the hook shaft, wherein the guide slot includes a helical portion for guiding the guide slot follower into rotation of the hook along a predetermined rotational angle upon linear advancement of the hook in the direction of the longitudinal axis.

3. A latch assembly, comprising:
a hook for securing a door of an appliance in a closed position, wherein the hook comprises a hook shaft extending along a longitudinal axis and a hook end configured at an angle to the longitudinal axis;
a hook guide for receiving and retaining the hook and configured to engage the hook shaft for rotation upon linear advancement in the direction of the longitudinal axis;
a hook block assembly for receiving and retaining the hook guide, wherein the hook block assembly comprises an internal guide slot configured to engage a guide slot follower protruding from the hook shaft, wherein the guide slot includes a helical portion for guiding the guide slot follower into rotation of the hook along a predetermined rotational angle upon linear advancement of the hook in the direction of the longitudinal axis;
a mechanical linkage connected to the hook guide for transmitting the linear advancement to the hook from a motor; and
an engagement slot of the door of the appliance configured to receive the hook end upon rotation, wherein the engagement slot and the hook end are configured for the securing of the door of the appliance in the closed position.

4. The latch assembly of claim 3, wherein the guide slot comprises a longitudinal portion parallel to the longitudinal axis for linearly guiding the guide slot follower, wherein the longitudinal portion connects with the helical portion.

5. The latch assembly of claim 4, wherein the guide slot follower comprises a cylindrical pin extending perpendicularly from the hook guide, to internally engage the guide slot.

6. The latch assembly of claim 3, wherein the predetermined rotational angle of the helical portion extends 90 degrees, to effect a quarter turn of rotation of the hook end into the engagement slot.

7. The latch assembly of claim 3, wherein the hook block assembly comprises a guide block matingly connected to a guide block cap, wherein the guide block and guide block cap comprise an internal bore for receiving and retaining in the hook guide, and wherein the guide slot comprises a channel formed within a surface of the internal bore of the guide block and the guide block cap of the hook block assembly.

8. The latch assembly of claim 7, wherein the guide block cap comprises an extension guide ramp that extends into the internal bore and includes a sloped contact surface of the helical portion for guiding the guide slot follower into rotation upon extension of the hook.

9. The latch assembly of claim 8, wherein the guide block comprises a retraction guide ramp matingly connected to the extension guide ramp and includes a mating contact surface of the helical portion for guiding the guide slot follower upon retraction of the hook.

10. The latch assembly of claim 3, wherein the mechanical linkage comprises a motor crank arm in connection with the motor for linearly displacing a link arm configured to rotate about a pivot post that displaces a hook arm in connection with the hook for transmitting the linear advancement from the motor.

11. The latch assembly of claim 10, wherein the pivot post comprises a hook arm lobe configured to rotate through a predetermined angle of rotation into a switch button of a hook position switch, wherein engagement of the hook arm lobe and the switch button generates a signal to discontinue the linear advancement of the motor.

12. The latch assembly of claim 3, wherein the latch assembly is mounted onto the appliance of an existing design and wherein the engagement slot comprises a ventilation slot of the door included in the existing design.

13. The latch assembly of claim 3, further comprising a latch base plate for mounting the hook guide with the hook, the mechanical linkage and the motor into a compact assembly unit.

14. A method of unlatching an appliance door, comprising:
providing an appliance having an electrically powered latch mechanism including a rotating hook for engaging a door of the appliance through a ventilation slot in the door;
operating the electrically powered latch mechanism to rotate the hook into engagement with the ventilation slot and thereby retain the door against the appliance in a closed position;
inserting a screwdriver into the ventilation slot to contact the engaged latch mechanism;
manually rotating the screwdriver to rotate the hook out of engagement with the ventilation slot and thereby release the door from the appliance; and
manually opening the door.

15. The method of claim 14, wherein the inserting of the screwdriver further comprises inserting a flat blade screwdriver into a screwdriver slot in the latch mechanism such that rotation of the screwdriver causes the hook to move in a reverse direction, thereby manually rotating the hook out of engagement with the ventilation slot.
